(19) United States
(12) Patent Application Publication
(10) Pub. No.: US 2009/0066452 A1
(43) Pub. Date: Mar. 12, 2009

(54) Magnetic levitation cushion and magnetic levitation for the same

(76) Inventor: Lo-Ping Hsu, Changzhi Hsiang (TW)

Correspondence Address: JACKSON WALKER, L.L.P., 112 E. PECAN, SUITE 2400, SAN ANTONIO, TX, 78205, US

(21) Appl. No.: 11/900,500

(22) Filed: Sep. 12, 2007

(51) Int. Cl. H01F 7/02

(52) U.S. Cl. 335/306

(57) ABSTRACT

A magnetic levitation cushion has multiple magnetic levitation devices, at least one assembling device and at least one supporting pad. The assembling device holds all the magnetic levitation devices as a group. Each magnetic levitation device has a housing, a fixed magnet assembly mounted securely in the housing, a movable magnet assembly being mounted slidably in the housing, movable relative to the fixed magnet assembly and a shaft with a bottom end connected to movable magnet. The supporting pad is mounted on a top end of each shaft. The magnetic levitation cushion is used as a cushion for upholstered furniture such as chairs, beds and sofas.

### BACKGROUND OF THE INVENTION

1. Field of the Invention

The present invention relates to a magnetic levitation cushion. In particular, a magnetic levitation cushion has a simple structure and can be applied for forming upholstery including mattresses, chairs, sofas, cushions for chairs and sofas and the like.

2. Description of the Prior Arts

Upholstery including mattresses for beds and cushions for chairs and the like comprise a resilient element being springs or latex.

When springs are implemented many metal springs are used to create a supporting force, and a level of comfort is determined by number of coils, wire diameter of the metal springs and lay out. Importantly, the springs used affect flexibility and hardness of the bed.

When the bed is too hard or soft, curvature of a person's spine is too great and this may cause back pain, injury, discomfort and loss of sleep.

Curvature of a child's spine in sleep is even more crucial since the spine is still growing, this may lead to deformation or malformation of the spine leading to chronic and permanent injury

Metal fatigue means that as the metal springs age, the springs will gradually weaken and the bed will be too soft to the detriment of an owner.

Furthermore, due to the complex internal structure, the spring bed accumulates considerable dirt and dust, thereby attracting microorganisms and insects to feed, including dust mites that causes allergic reaction in many people, especially asthma sufferers where this allergy can become fatal. However, the conventional bed cannot be dismantled for regular cleaning so this issue can never be solved adequetely.

Finally, a spring may break or fail, and because the springs cannot be replaced, the owner is forced to replace the mattress.

Latex beds conform to a user's body. However, because of the high density of the latex rubber material, latex tends to trap heat and perspiration causing discomfort, skin disease or infection. Furthermore, latex in latex beds becomes hard and crumbles.

To overcome the shortcomings, the present invention provides a magnetic levitation cushion to mitigate or obviate the aforementioned problems.

### SUMMARY OF THE INVENTION

The main objective of the present invention is to provide a magnetic levitation cushion using mutual magnetic repulsion as a supporting force for the cushion. Since the magnetic force provided by permanent magnets can last for a long time, the magnetic levitation cushion has a long lifespan and may be replaced easily without drawbacks such as metal fatigue of springs and material hardening and crumbling of latex.

To achieve the objective, the magnetic levitation cushion has multiple magnetic levitation devices, at least one assembling device and at least one supporting pad. The assembling device holds all the magnetic levitation devices as a group. Each magnetic levitation device has a housing, a fixed magnet assembly being mounted securely in the housing, a movable magnet assembly being mounted slidably in the housing and movably relative to the fixed magnet assembly and a shaft with a bottom end connected to the movable magnet assembly. The supporting pad is mounted on the top end of each shaft. The magnetic levitation cushion is used as a cushion for upholstered furniture such as chairs, beds and sofas.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional view of a section of a first embodiment of a magnetic levitation cushion in accordance with the present invention;

FIG. 2 is a cross sectional view of a section of a second embodiment of a magnetic levitation cushion in accordance with the present invention;

FIG. 3 is a top view of multiple magnetic levitation tubes being assembled as a group in accordance with the present invention;

FIG. 4 is an exploded perspective view of the magnetic levitation tube in accordance with the present invention;

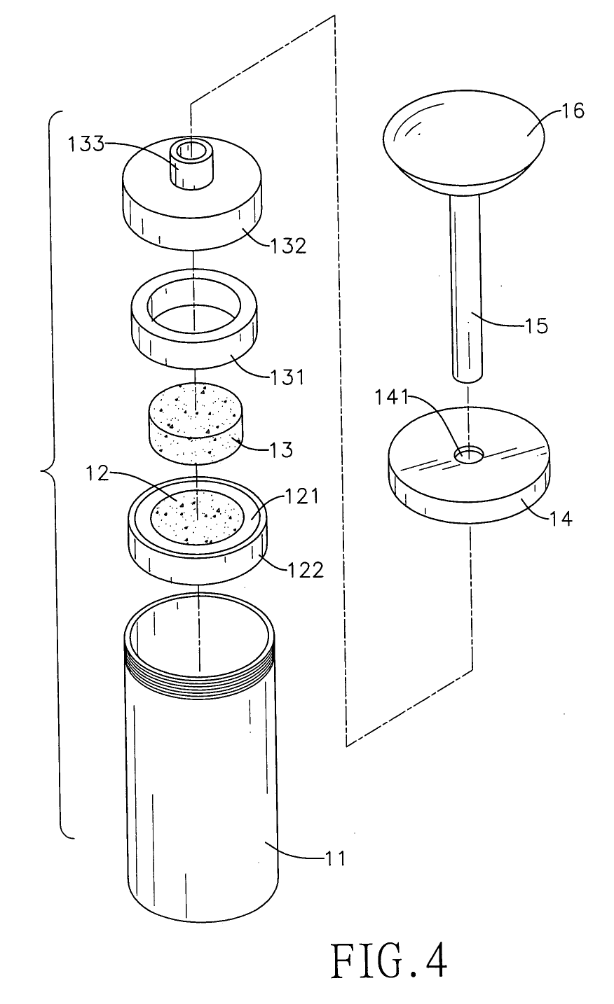

FIG. 5 is a perspective view of the magnetic levitation tube of FIG. 4; and

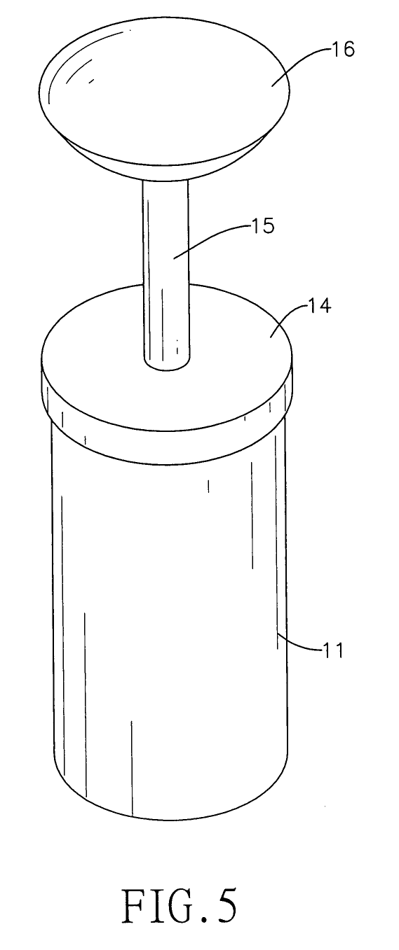

FIG. 6 is cross sectional view of the magnetic levitation tube with multiple granulated protrusions in accordance with the present invention.

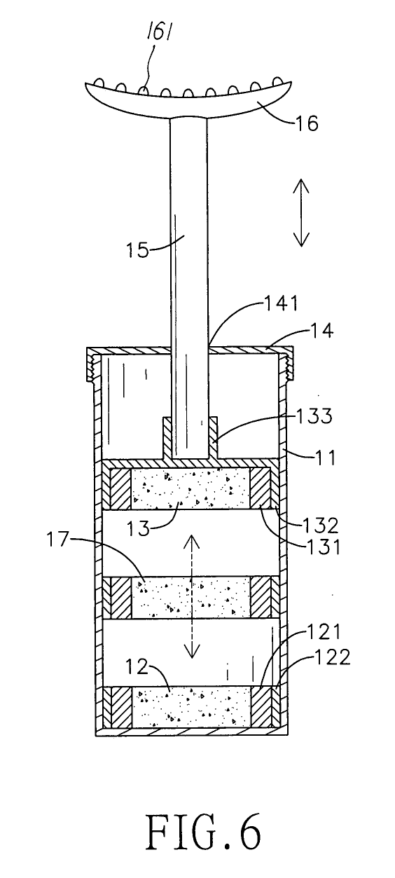

### DETAILED DESCRIPTION OF THE PREFERRED EMBODIMENTS

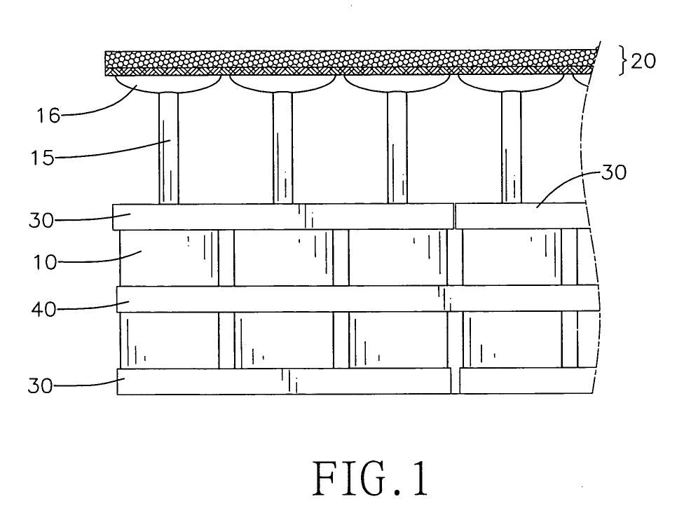

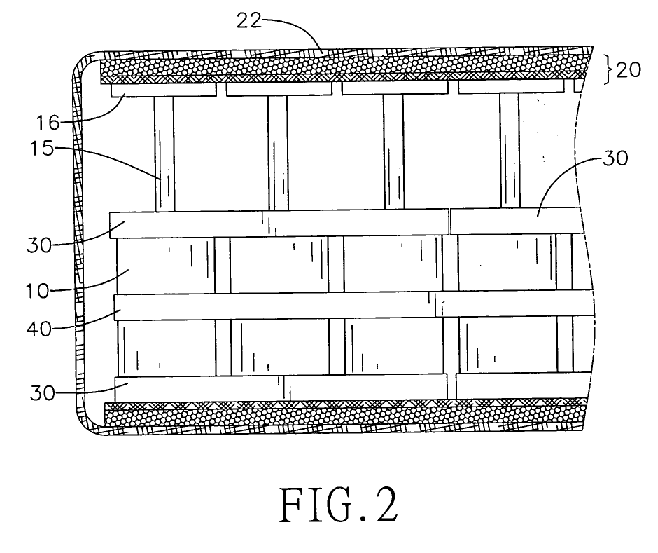

With reference to FIGS. 1 and 2, a magnetic levitation cushion in accordance with the present invention comprises multiple magnetic levitation devices (10), an assembling device, at least one supporting pad (16) and an optional material layer (20).

The multiple magnetic levitation devices (10) are bound together using the assembling device and may form magnetic levitation units or be arranged as an array.

Each magnetic levitation device (10) comprises a housing (11), a fixed magnet assembly (12), a movable magnet assembly (13), an optional cover (14), a shaft (15) and at least one optional mid-magnet assembly (17).

The housing (11) has a closed bottom, an open top and may be circular, square or such like in cross section. The housing (11) may further be non-symmetrical in cross section to prevent the magnet assemblies (12, 13, 17) from flipping over and attracting each other.

The fixed magnet assembly (12), movable magnet assembly (13) and mid-magnet assembly (17) correspond to and are mounted inside the housing (11) and comprise a permanent magnet, an optional iron ring (121, 131) and an optional plastic case (122, 132). The iron ring (121, 131) is mounted around the permanent magnet. The plastic case (122, 132) is mounted around the iron ring (121, 131).

The fixed magnet assembly (12) is mounted securely on the bottom of the housing (11).

The movable magnet assembly (13) is mounted slidably inside the housing (11), movably relative to the fixed magnet assembly (12) and has a top surface. The plastic case (132) of the movable magnet assembly (13) may further extend over and form a sleeve (133) on the top surface of the movable magnet assembly (13).

Since the fixed and movable magnet assemblies (12, 13) face each other with a same magnetic pole, the two magnet assemblies (12, 13) repel each other and are held apart by a distance due to magnetic repulsion.

The cover (14) is mounted on the open top of the housing (11) and comprises a through hole (141) corresponding to the shaft (15).

The shaft (15) has a bottom end and a top end. The bottom end is connected to the movable magnet (13) and may be mounted though the through hole (141) of the cover (14) and is mounted on the top surface of the movable magnet assembly (13), may be in the sleeve (133) of the second plastic case (131).

The supporting pad (16) is a soft and resilient material such as rubber or plastic and has a top surface being either flat or curved, and may further have multiple soft and resilient granulated protrusions (161) formed on the top surface of the supporting pad to make the magnetic levitation cushion more comfortable and increase air ventilation.

In one embodiment of the present invention, a single supporting pad (16) with a large area is mounted on the top ends of all the shafts (15).

In another embodiment, multiple supporting pads (16) are mounted respectively on the top end of each shafts (15).

In another embodiment, single supporting pads (16) are mounted on the top ends of a group of shafts (15) to form multiple magnetic levitation units.

The mid-magnet assembly (17) is mounted between the fixed magnet assembly (12) and the movable magnet assembly (13) inside the housing (11).

The material layer (20) is mounted on the supporting pads (16) and may be a single layer structure or a multi-layer structure composed of soft material such as, but not limited to textiles.

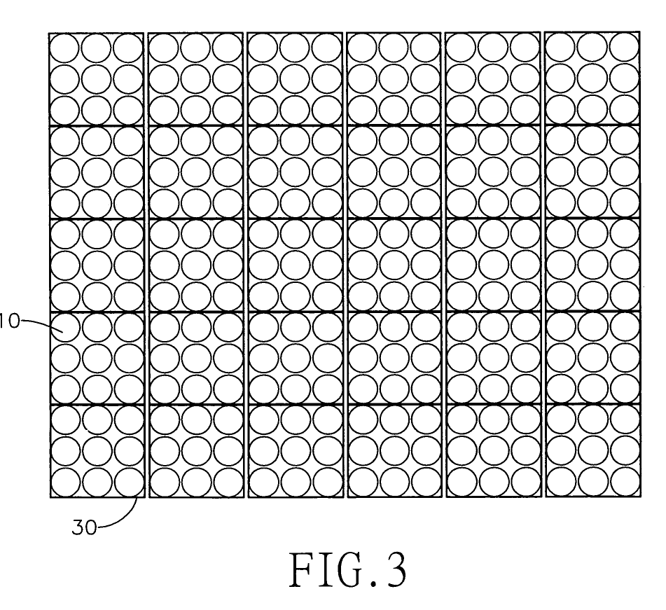

With further reference to FIG. 3, the assembling device holds the magnetic levitation devices (10) and magnetic levitation units together as a group and comprises at least one frame (30), at least one strap (40) or any combination therein.

Each frame (30) is mounted around a number of magnetic levitation devices (10) to hold the magnetic levitation devices (10) together as a magnetic levitation unit. Therefore, multiple units of the magnetic levitation tubes (10) can be arranged easily in an ordered shape. The number of the magnetic levitation devices (10) enclosed by each frame (30) is dependent on practical applications. Therefore, a size of the frame (30) is designed to meet practical applications.

The strap (40) ties units of the magnetic levitation devices (10) together. Multiple straps (40) may be used to reinforce binding strength. The straps (40) may be removed by a user to allow easy replacement of single units or for cleaning and maintenance.

As an example application, the present invention can be used as a mattress and base for a bed. A cloth layer (22) encloses the magnetic levitation devices to improve aesthetic appeal of the mattress.

When an object or a person applies a force against the material layer (20) or the cloth layer (22), the magnetic repulsion between the magnet assemblies (12, 13, 17) is used to resist and cushion this force. Since the magnet assemblies (12, 13, 17) are all mounted in a housing (11), the movable magnet (13) can only move parallel with the housing (11) without perpendicular shift.

In conclusion, the present invention can be used as a structure for upholstered furniture. Using permanent magnets holding magnetism for a long time, the furniture has a long lifespan. Furthermore, the present invention also has advantages as follows.

1. Easy to clean: The user can dismantle the magnetic levitation cushion by themselves for internal cleaning.

2. Easy to repair: Damaged magnetic levitation devices (10) or units in the magnetic levitation cushion can be individually replaced. Therefore, the furniture need not be disposed of if one unit or device fails.

3. Superior air ventilation: Since the material layer need only provide aesthetic appearance, the material layer may be very thin and therefore allow air to circulate around a person's body.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A magnetic levitation cushion comprising:
multiple magnetic levitation devices, each magnetic levitation device having
a housing having a closed bottom and an open top;
a fixed magnet assembly corresponding to and being mounted on the closed bottom inside the housing and comprising a permanent magnet;
a movable magnet assembly corresponding to and being mounted slidably inside the housing, movable relative to and comprising a permanent magnet facing the permanent magnet of the fixed magnet assembly with a same magnetic pole, and having a top surface; and
a shaft having
a bottom end being mounted on the top surface of the movable magnet; and
a top end;
an assembling device holding magnetic levitation devices as a unit; and
at least one supporting pad mounted on the top ends of the shafts.

2. The magnetic levitation cushion as claimed in claim 1 comprising multiple supporting pads, wherein the supporting pads are mounted respectively on the top end of each shaft.

3. The magnetic levitation cushion as claimed in claim 2 further comprising a material layer being mounted on the supporting pads.

4. The magnetic levitation cushion as claimed in claim 3, wherein each magnetic levitation device further has a cover being mounted on the open top of the housing and having a through hole, corresponding to the shaft formed through the cover.

5. The magnetic levitation cushion as claimed in claim 4, wherein each magnetic levitation device further has at least one mid-magnet being mounted between the fixed magnet assembly and the movable magnet assembly inside the housing.

6. The magnetic levitation cushion as claimed in claim 5, wherein each magnet assembly further comprises
an iron ring being mounted around the permanent magnet; and
a plastic case being mounted around the iron ring.

7. The magnetic levitation cushion as claimed in claim 6, wherein
the plastic case of the movable magnet assembly further extends over and forms a sleeve on the top surface of the movable magnet assembly; and
the shaft is mounted securely in the sleeve of the movable magnet assembly.

8. The magnetic levitation cushion as claimed in claim 7, wherein the assembling device further comprises
at least one frame being mounted around the magnetic levitation devices to hold the magnetic levitation devices together as a magnetic levitation unit; and
at least one strap ties the magnetic levitation units together.

9. The magnetic levitation cushion as claimed in claim 8, wherein the supporting pad has a top surface being either flat or curved.

10. The magnetic levitation cushion as claimed in claim 9, wherein the supporting pad comprises multiple granulated protrusions being formed on the top surface of the supporting pad.

12. A magnetic levitation device comprising:
a housing having a closed bottom and an open top;
a fixed magnet assembly corresponding to and being mounted on the closed bottom inside the housing and comprising a permanent magnet;
a movable magnet assembly corresponding to and being mounted slidably inside the housing, movable relative to and comprising a permanent magnet facing the permanent magnet of the fixed magnet assembly with a same magnetic pole, and having a top surface; and
a shaft having a bottom end being mounted on the top surface of the movable magnet and a top end;
a supporting pad mounted on the top end of the shaft.

13. The magnetic levitation device as claimed in claim 12 further having a cover being mounted on the open top of the housing and having a through hole, corresponding to the shaft formed through the cover.

14. The magnetic levitation cushion as claimed in claim 13 further having at least one mid-magnet being mounted between the fixed magnet assembly and the movable magnet assembly inside the housing.

15. The magnetic levitation cushion as claimed in claim 14, wherein each magnet assembly further comprises
an iron ring being mounted around the permanent magnet; and
a plastic case being mounted around the iron ring.

16. The magnetic levitation cushion as claimed in claim 15, wherein
the plastic case of the movable magnet assembly further extends over and forms a sleeve on the top surface of the movable magnet assembly; and
the shaft is mounted securely in the sleeve of the movable magnet assembly.

17. The magnetic levitation cushion as claimed in claim 16, wherein the supporting pad comprises multiple granulated protrusions being formed on the top surface of the supporting pad.
